(19) United States
(12) Patent Application Publication
(10) Pub. No.: US 2016/0260353 A1
(43) Pub. Date: Sep. 8, 2016

(54) OBJECT RECOGNITION FOR THE VISUALLY IMPAIRED

(71) Applicant: Arjun Kundan Dhawan, Newburgh, IN (US)

(72) Inventor: Arjun Kundan Dhawan, Newburgh, IN (US)

(21) Appl. No.: 14/637,495

(22) Filed: Mar. 4, 2015

(51) Int. Cl. G09B 21/00; H04N 13/02

(52) U.S. Cl. CPC G09B 21/001; H04N 13/0203

(57) ABSTRACT

A three-dimensional sensor device is shown that may include a sensor network comprising one or more sensors configured to detect conditions proximate to the three-dimensional sensor device, a speech recognition module configured to detect and respond to operator speech patterns, an object detection module configured to detect objects proximate to the three-dimensional sensor device using contact-less detection, and a classification module configured to compare images received from the sensor network with known images stored in the image library or features of images that the sensor device has been trained to recognize. The three-dimensional sensor device may have improved qualities of object recognition for the visually impaired.

### FIELD OF THE INVENTION

The following invention generally relates to three-dimensional sensors and more particularly to three-dimensional sensors configured to recognize an object and independently guide the visually impaired to its location.

### BACKGROUND OF THE INVENTION

Over 285 million people are visually impaired or blind in the world today. While technologies and sensors are in common use in automobiles for safety, in consumer devices for convenience, in airports for security, and in general for global connectivity, the use of these types of technologies has not been sufficiently expanded to help the visually impaired.

Specifically, sensor technology has been developed and is widely used for facial recognition. Furthermore, technologies to recognize specific objects have also been developed and modified. While advances continue to be made in facial and object detection, they have not been tailored to improve the lives of the visually impaired. Previous work in helping the visually impaired has been limited to navigation, whereby obstacles in the path are detected via an electronic cane.

Therefore, there at least remains a need in the art for the availability of a means of using sensor technology to aid the visually impaired by providing a means of object recognition and detection.

### SUMMARY OF THE INVENTION

One or more embodiments of the invention may address one or more of the aforementioned problems. For example, certain exemplary embodiments according to the present invention provide a three-dimensional sensor device. In such embodiments, the three-dimensional sensor device may include a sensor network comprising one or more sensors configured to detect conditions proximate to the three-dimensional sensor device, a speech recognition module configured to detect and respond to operator speech patterns, an object detection module configured to detect objects proximate to the three-dimensional sensor device using contact-less detection, and a classification module configured to compare images received from the sensor network with known images stored in the image library or features of images that the sensor device has been trained to recognize.

In another aspect, the present invention provides a method of object recognition. In such exemplary embodiments, the method includes detecting operator speech instructing a three-dimensional sensor device to find an object, capturing an image, classifying the object in the image, detecting location information of the object relative to the operator, and conveying the distance information to the operator.

In another aspect, the present invention provides a method of object recognition. In such exemplary embodiments, the method includes detecting operator speech instructing a three-dimensional sensor device to find an object, capturing an image, classifying the object in the image, detecting location information of the object relative to the operator, and conveying the distance information to the operator wherein the three-dimensional sensor device comprises processing circuitry configured for detecting operator speech instructing a three-dimensional sensor device to find an object; capturing an image; classifying the object in the image; detecting location information of the object relative to the operator; and conveying the location information to the operator (who may be visually impaired) until the object is found.

### BRIEF DESCRIPTION OF THE DRAWINGS

The present invention now will be described more fully hereinafter with reference to the accompanying drawings, in which some, but not all embodiments of the invention are shown. The present invention may be embodied in many different forms and should not be construed as limited to the embodiments set forth herein; rather, these embodiments are provided so that this disclosure will satisfy applicable legal requirements and demonstrate exemplary embodiments of the invention. Repeat use of reference characters in the present specification and drawings is intended to represent same or analogous features or elements of the invention.

FIG. 1 illustrates a front view in elevation of a three-dimensional sensor device according to certain embodiments of the present invention.

FIG. 2 illustrates a block diagram of various components of control circuitry to identify some of the components that enable or enhance the functional performance of the three-dimensional sensor device according to certain embodiments of the present invention.

FIG. 3 illustrates a block diagram of some components that may be employed as part of a sensor network according to certain embodiments of the present invention.

FIG. 4 illustrates a block diagram of a method according to certain embodiments of the present invention.

FIG. 5 illustrates a control flow diagram of one example of how the three-dimensional sensor device can be operated to locate objects according to certain embodiments of the present invention.

FIG. 6 illustrates a control flow diagram of the operation of the basic algorithm according to certain embodiments of the present invention.

FIG. 7 illustrates specked dots of IR light projected onto an object using the three-dimensional sensor device according to certain embodiments of the present invention.

FIG. 8 illustrates the effects of object size and distance of object from the three-dimensional sensor device on accuracy of sensor-reported distance of object from the three-dimensional sensor device.

FIG. 9 illustrates the effects of object size on detection range of the three-dimensional sensor device.

FIG. 10 illustrates the effects of background color on detection of the object by a three-dimensional sensor device.

### DETAILED DESCRIPTION OF PREFERRED EMBODIMENTS

Reference will now be made in detail to exemplary embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The present invention includes a three-dimensional sensor device configured to improve object recognition for the visually impaired. The three-dimensional sensor device may include a sensor network comprising one or more sensors configured to detect conditions proximate to the three-dimensional sensor device, a speech recognition module configured to detect and respond to operator speech patterns, an object detection module configured to detect objects proximate to the three-dimensional sensor device using contact-less detection, and a classification module configured to compare images received from the sensor network with known images stored in the image library or features of images that the sensor device has been trained to recognize.

In an example embodiment, a three-dimensional sensor device is provided with a speech recognition module, an object detection module, a classification module, and a sensor network. The speech recognition module may be configured to detect and respond to operator speech patterns. The object detection module may be configured to detect objects proximate to the three-dimensional sensor device to enable the three-dimensional sensor device to identify objects without physically contacting them. The classification module may be configured to utilize one or more sensors to compare images of objects located in the area around the three-dimensional sensor device with known object images in an image library. The sensor network may be configured to collect data (e.g., image data, distance data, etc.). Other structures may also be provided, and other functions may also be performed as described in greater detail below.

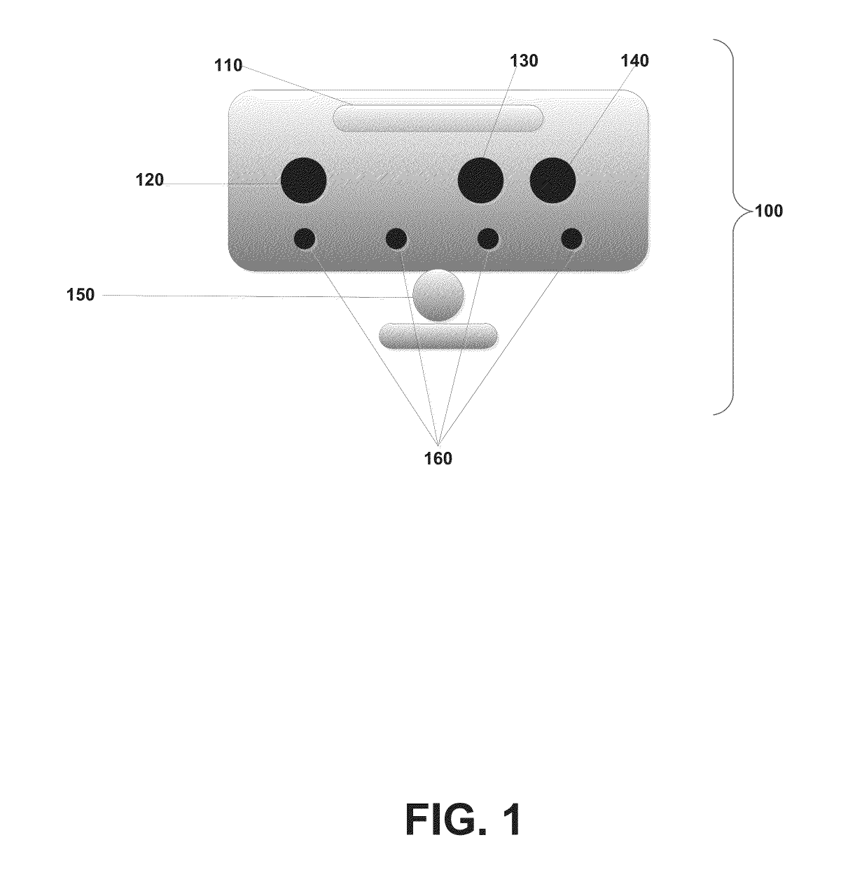

FIG. 1 illustrates a front view in elevation of a three-dimensional sensor 100 device according to an example embodiment. However, it should be appreciated that example embodiments may be employed in numerous other sensor devices, so the three-dimensional sensor device 100 should be recognized as merely one example of such a sensor device. The three-dimensional sensor device 100 may be controlled, at least in part, via control circuitry 110 located onboard. The control circuitry 110 may include, among other things, a speech recognition module 250, an object detection module 240, a classification module 260, and a sensor network 280, which will be described in greater detail below. Accordingly, the three-dimensional sensor device 100 may utilize the control circuitry 110 to recognize objects and provide an auditory response based on the position of objects relative to the three-dimensional sensor device 100. In this regard, the speech recognition module 250 may be used to detect and respond to operator speech patterns, the object detection module 240 may be used to detect objects proximate to the three-dimensional sensor device 100 to enable the three-dimensional sensor device 100 to identify objects without physically contacting them, the classification module 260 may be used to classify objects located in the area around the three-dimensional sensor device 100, while the sensor network 280 may gather data regarding the surroundings of the three-dimensional sensor device 100.

If a sensor network is employed, the sensor network 280 may include sensors relating to depth determination. Accordingly, the sensors may be used, at least in part, for determining the location of objects relative to the three-dimensional sensor device 100. As such, the three-dimensional sensor device 100 may include an IR emitter 120 and an IR depth sensor 140. The sensors may also detect object classification information (e.g., color). As such, the three-dimensional sensor device 100 may include a color sensor 130. In some cases, the sensors may also detect the tilt and/or leveling of the three-dimensional sensor device 100. As such, the three-dimensional sensor device 100 may include a leveling sensor 150. The sensor may further detect and respond to operator speech. As such, the three-dimensional sensor device 100 may include at least one voice sensor 160.

In an example embodiment, the three-dimensional sensor device 100 may be battery powered via one or more rechargeable batteries. Accordingly, the three-dimensional sensor device 100 may be configured to be placed in a charge station in order to recharge the batteries. Alternatively, the three-dimensional sensor device 100 may be powered by an AC/DC power supply.

In an example embodiment, the three-dimensional sensor device 100 may be positioned in a wearable item. In certain embodiments, the wearable item may comprise a harness, glasses, or apparel. As such, the three-dimensional sensor device 100 may be portable so that the operator may utilize the three-dimensional sensor device 100 wherever the operator has a need for object recognition and detection.

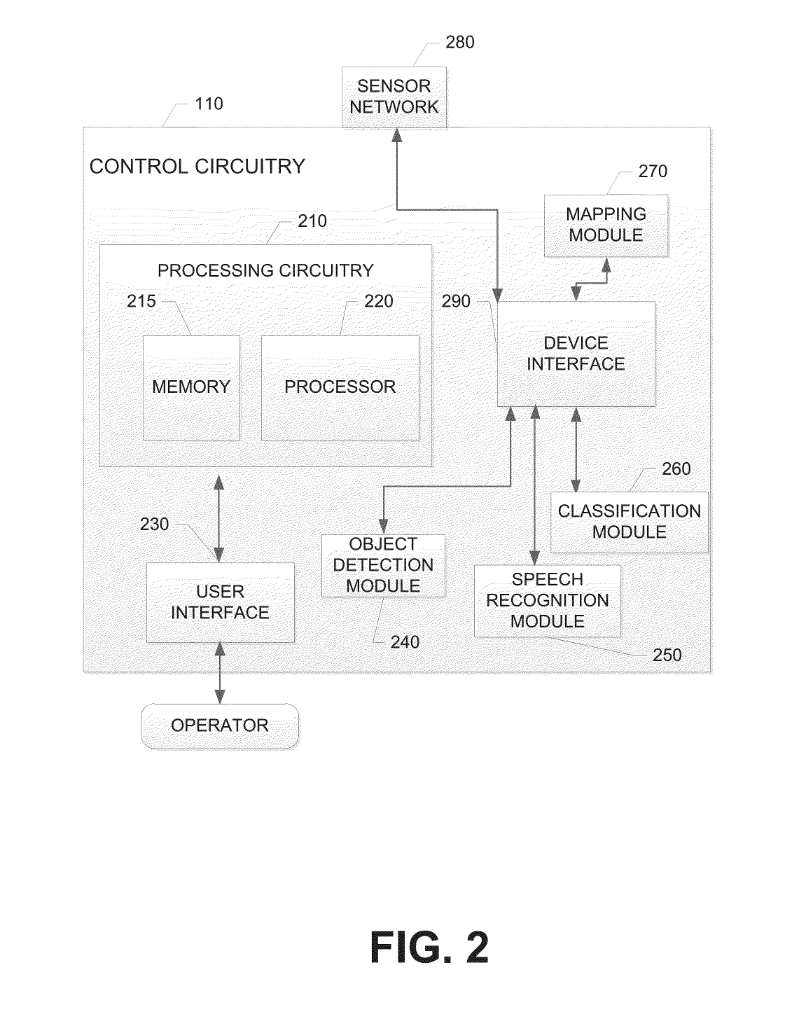

Some examples of the interactions that may be enabled by example embodiments will be described herein by way of explanation and not of limitation. FIG. 2 illustrates a block diagram of various components of the control circuitry 110 to identify some of the components that enable or enhance the functional performance of the three-dimensional sensor device 100 and to facilitate description of an example embodiment. In some example embodiments, the control circuitry 110 may include or otherwise be in communication with an object detection module 240, a speech recognition module 250, and a classification module 260. As mentioned above, the object detection module 240, speech recognition module 250, and classification module 260 may work together to give the three-dimensional sensor device 100 a comprehensive understanding of its environment and enable it to detect and classify objects that it encounters in a given area.

The control circuitry 110 may also optionally include or otherwise be in communication with a mapping module 270. The mapping module 270 may be configured to generate an auditory map of the current positions of objects in an area in which the three-dimensional sensor device 100 operates. Specifically, the mapping module 270 may be configured to incorporate input from one or more sensors to determine the current positions of multiple objects in the area in which the three-dimensional sensor device 100 operates. Additionally, the mapping module 270 may be configured to facilitate operation of the three-dimensional sensor device 100 relative to an existing (or previously generated) auditory map of the area.

Any or all of the object detection module 240, speech recognition module 250, classification module 260, and mapping module 270 may be part of a sensor network 280 of the three-dimensional sensor device 100. However, in some cases, any or all of the object detection module 240, speech recognition module 250, classification module 260, and mapping module 270 may be in communication with the sensor network 280 to facilitate operation of each respective module.

In some examples, one or more of the object detection module 240, speech recognition module 250, classification module 260, and mapping module 270 may further include or be in communication with at least one camera 135 and/or other imaging device. The camera 135 may be a part of the sensor network 280, part of any of the modules described above, or may be in communication with one or more of the modules to enhance, enable, or otherwise facilitate operation of respective ones of the modules. The camera 135 may include an electronic image sensor configured to store captured image data (e.g., in memory 215). Image data recorded by the camera 135 may be in the visible light spectrum or in other portions of the electromagnetic spectrum (e.g., IR camera). In some cases, the camera 135 may actually include multiple sensors configured to capture data in different types of images (e.g., RGB, IR, and grayscale sensors). The camera 135 may be configured to capture still images and/or video data.

The control circuitry 110 may include processing circuitry 210 that may be configured to perform data processing or control function execution and/or other processing and management services according to an example embodiment of the present invention. In some embodiments, the processing circuitry 210 may be embodied as a chip or chip set. In other words, the processing circuitry 210 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 210 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 210 may include one or more instances of a processor 215 and memory 220 that may be in communication with or otherwise control a device interface 290 and, in some cases, a user interface 230. As such, the processing circuitry 210 may be embodied as a circuit chip (e.g., an integrated circuit chip) configured (e.g., with hardware, software or a combination of hardware and software) to perform operations described herein. However, in some embodiments, the processing circuitry 210 may be embodied as a portion of an onboard computer. In some embodiments, the processing circuitry 210 may communicate with electronic components and/or sensors of the three-dimensional sensor device 100 via a single data bus. As such, the data bus may connect to a plurality or all of the switching components, sensory components and/or other electrically controlled components of the three-dimensional sensor device 100.

The processor 215 may be embodied in a number of different ways. For example, the processor 215 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 215 may be configured to execute instructions stored in the memory 220 or otherwise accessible to the processor 215. As such, whether configured by hardware or by a combination of hardware and software, the processor 215 may represent an entity (e.g., physically embodied in circuitry—in the form of processing circuitry 210) capable of performing operations according to embodiments of the present invention while configured accordingly. Thus, for example, when the processor 215 is embodied as an ASIC, FPGA, or the like, the processor 215 may be specifically configured hardware for conducting the operations described herein. Alternatively, as another example, when the processor 215 is embodied as an executor of software instructions, the instructions may specifically configure the processor 215 to perform the operations described herein.

In an example embodiment, the processor 215 (or the processing circuitry 210) may be embodied as, include, or otherwise control the object detection module 240, speech recognition module 250, classification module 260, mapping module 270, and/or the sensor network 280 of the three-dimensional sensor device 100. As such, in some embodiments, the processor 215 (or the processing circuitry 210) may be said to cause each of the operations described in connection with the object detection module 240, speech recognition module 250, classification module 260, mapping module 270, and/or the sensor network 280 by directing the object detection module 240, speech recognition module 250, classification module 260, mapping module 270, and/or the sensor network 280, respectively, to undertake the corresponding functionalities responsive to execution of instructions or algorithms configuring the processor 215 (or processing circuitry 210) accordingly. These instructions or algorithms may configure the processing circuitry 210, and thereby also the three-dimensional sensor device 100, into a tool for driving the corresponding physical components for performing corresponding functions in the physical world in accordance with the instructions provided.

In an exemplary embodiment, the memory 220 may include one or more non-transitory memory devices such as, for example, volatile and/or non-volatile memory that may be either fixed or removable. The memory 220 may be configured to store information, data, applications, instructions or the like for enabling the object detection module 240, speech recognition module 250, classification module 260, mapping module 270, and/or the sensor network 280 to carry out various functions in accordance with exemplary embodiments of the present invention. For example, the memory 220 could be configured to buffer input data for processing by the processor 215. Additionally or alternatively, the memory 220 could be configured to store instructions for execution by the processor 215. As yet another alternative, the memory 220 may include one or more databases that may store a variety of data sets responsive to input from various sensors or components of the three-dimensional sensor device 100. Among the contents of the memory 220, applications may be stored for execution by the processor 215 in order to carry out the functionality associated with each respective application.

The applications may include applications for controlling the three-dimensional sensor device 100 relative to various operations including determining an accurate position of objects relative to the three-dimensional sensor device 100 (e.g., using one or more sensors of the object detection module 240). Alternatively or additionally, the applications may include applications for controlling the three-dimensional sensor device 100 relative to various operations including recognizing operator speech patterns and audibly responding to operator speech patterns (e.g., using one or more sensors of the speech recognition module 250). Alternatively or additionally, the applications may include applications for controlling the three-dimensional sensor device 100 relative to various operations including comparing images of objects encountered in an area with images of known objects (e.g., clocks, chairs, tables and/or the like) from an image library (e.g., using one or more sensors of the classification module 260). Alternatively or additionally, the applications may include applications for controlling the three-dimensional sensor device 100 relative to various operations including generating an auditory map of an area in which the three-dimensional sensor device 100 operates (e.g., using one or more sensors of the mapping module 270). Alternatively or additionally, the applications may include applications for controlling the camera 135 and/or processing image data gathered by the camera 135 to execute or facilitate execution of other applications that drive or enhance operation of the three-dimensional sensor device 100 relative to various activities described herein.

The user interface 230 (if implemented) may be in communication with the processing circuitry 210 to receive an indication of a user input at the user interface 230 and/or to provide an audible, visual, mechanical, or other output to the user. As such, the user interface 230 may include, for example, a display, one or more buttons or keys (e.g., function buttons), and/or other input/output mechanisms (e.g., voice sensor, speakers, cursor, joystick, lights and/or the like).

The device interface 290 may include one or more interface mechanisms for enabling communication with other devices either locally or remotely. In some cases, the device interface 290 may be any means such as a device or circuitry embodied in either hardware, or a combination of hardware and software that is configured to receive and/or transmit data from/to sensors or other components in communication with the processing circuitry 210. In some example embodiments, the device interface 290 may provide interfaces for communication of data to/from the control circuitry 110, the object detection module 240, the speech recognition module 250, the classification module 260, the mapping module 270, the sensor network 280, and/or the camera 135 via wired or wireless communication interfaces in a real-time manner, as a data package downloaded after data gathering or in one or more burst transmission of any kind.

Each of the object detection module 240, the speech recognition module 250, the classification module 260, and the mapping module 270 may be any means such as a device or circuitry embodied in either hardware, or a combination of hardware and software that is configured to perform the corresponding functions described herein. Thus, the modules may include hardware and/or instructions for execution on hardware (e.g., embedded processing circuitry) that is part of the control circuitry 110 of the three-dimensional sensor device 100. The modules may share some parts of the hardware and/or instructions that form each module, or they may be distinctly formed. As such, the modules and components thereof are not necessarily intended to be mutually exclusive relative to each other from a compositional perspective.

In an example embodiment, the object detection module 240 may be configured to utilize one or more sensors (e.g., of the sensor network 280) to detect objects located in the area around the three-dimensional sensor device 100 to enable the three-dimensional sensor device 100 to identify the objects and determine the position of the objects relative to the three-dimensional sensor device 100 without contacting them. Thus, the three-dimensional sensor device 100 (or more specifically, the control circuitry 110) may utilize object detection information to determine the distance between an object and the three-dimensional sensor device 100. The objection detection module 240 may therefore be configured to detect static (i.e., fixed or permanent) and/or dynamic (i.e., temporary or moving) objects in the vicinity of the three-dimensional sensor device 100. Moreover, in some cases, the object detection module 240 may interact with the speech recognition module 250 to report the distance between an object and the three-dimensional sensor device 100 to an operator (who may be visually impaired).

Various sensors of sensor network 280 of the three-dimensional sensor device 100 may be included as a portion of, or otherwise communicate with, the object detection module 240 to, for example, determine the existence of objects, determine range to objects, determine direction to objects, classify objects, and/or the like.

In an example embodiment, the speech recognition module 250 may be configured to utilize one or more sensors (e.g., of the sensor network 280) to detect and respond to operator speech patterns. Thus, the speech recognition module 250 may include components that enable the three-dimensional sensor device 100 to understand and follow operator instructions. In some cases, the speech recognition module 250 may interact with the object detection module 240 as discussed above to detect operator instructions to find an object, detect an object within an image, and audibly notify the operator when the object has been detected. As such, the three-dimensional sensor device 100 (or more specifically, the control circuitry 110) may facilitate object recognition and communication with an operator.

Various sensors of sensor network 280 of the three-dimensional sensor device 100 may be included as a portion of, or otherwise communicate with, the speech recognition module 250 to, for example, detect operator speech patterns, understand operator instructions to locate an object, detect the object, audibly notify the operator of the position of an object, and/or the like.

In an example embodiment, the classification module 260 may be configured to utilize one or more sensors (e.g., of the sensor network 280) to classify objects detected around the three-dimensional sensor device 100. Thus, the classification module 260 may include components that enable the three-dimensional sensor device 100 to compare images of objects with images of known objects (e.g., clocks, chairs, tables and/or the like) from an image library or images that the three-dimensional sensor device 100 has been trained to recognize in order to classify the objects. Accordingly, the classification module 260 may enable the three-dimensional sensor device 100 to compare and classify objects based on images of the objects that the three-dimensional sensor device 100 encounters using, for example, an RGB camera during operation. Alternatively or in addition, the classification module 260 may enable the three-dimensional sensor device 100 to compare and classify objects based on color images as will be described in more detail below. Thus, for example, the classification module 260 may enable data gathered to be used to classify objects that the three-dimensional sensor device 100 encounters during operation by comparing images of the encountered objects with images of known objects (e.g., clocks, chairs, tables and/or the like) stored in an image library or images that the three-dimensional sensor device 100 has been trained to recognize.

Various sensors of sensor network 280 of the three-dimensional sensor device 100 may be included as a portion of, or otherwise communicate with, the classification module 260 to, for example, build an image library of the various objects encountered by the three-dimensional sensor device 100 so that the image library can be used for comparison and classification of objects by the three-dimensional sensor device 100.

In an example embodiment, the mapping module 270 may be configured to utilize one or more sensors (e.g., of the sensor network 280) to generate an auditory map of the current positions of objects in an area in which the three-dimensional sensor device 100 operates. Thus, the mapping module 270 may include components that enable the three-dimensional sensor device 100 to interact with the object detection module 240 and/or incorporate input from one or more sensors to determine the current position of multiple objects in the area in which the three-dimensional sensor device 100 operates. Additionally, the mapping module 270 may be configured to facilitate operation of the three-dimensional sensor device 100 relative to an existing (or previously generated) auditory map of the area. As such, the three-dimensional sensor device 100 (or more specifically, the control circuitry 110) may facilitate auditory map generation of objects located in an area, whether familiar or unfamiliar, in which the three-dimensional sensor device 100 operates. In this regard, when a visually impaired person walks into an unfamiliar place, the three-dimensional sensor device 100 may generate an auditory map of the area based on features of specific objects the three-dimensional sensor device 100 has been trained to recognize.

Various sensors of sensor network 280 of the three-dimensional sensor device 100 may be included as a portion of, or otherwise communicate with, the mapping module 270 to, for example, generate an auditory map of multiple objects and facilitate operation of the three-dimensional sensor device 100 relative to a previously generated auditory map of the objects in an area.

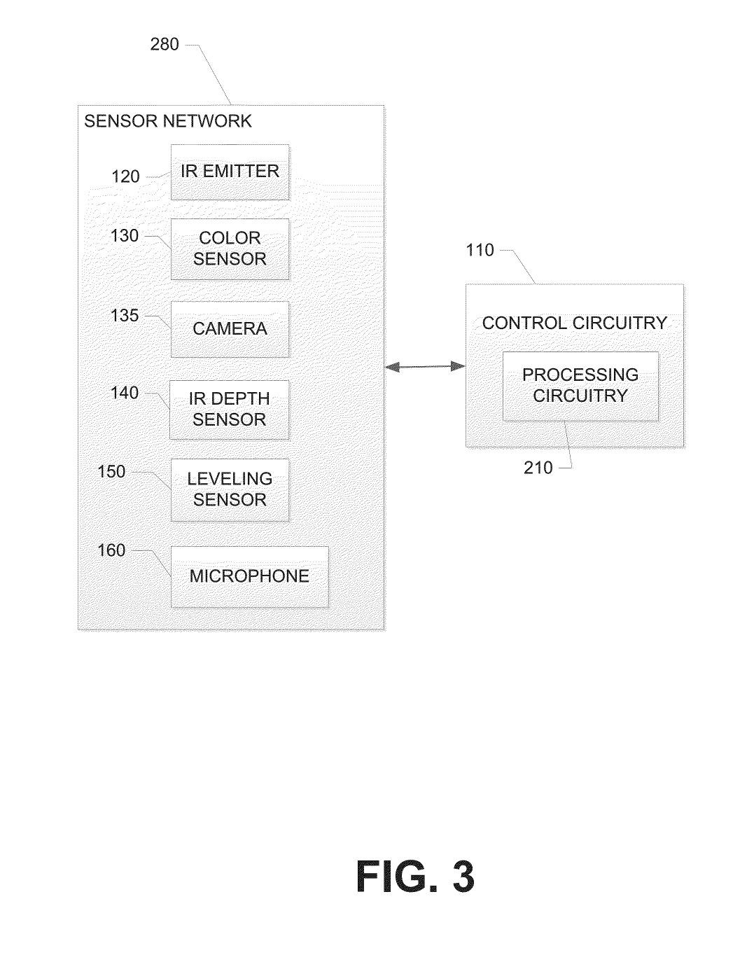

In an example embodiment, the sensor network 280 may provide data to the modules described above to facilitate execution of the functions described above and/or any other functions that the modules may be configurable to perform. In some cases, the sensor network 280 may include (perhaps among other things) any or all of an IR emitter 120, a color sensor 130, a camera 135, an IR depth sensor 140, a leveling sensor 150, and a voice sensor 160, as shown in FIG. 3. In this regard, FIG. 3 illustrates a block diagram of some components that may be employed as part of a sensor network 280 according to certain embodiments of the present invention.

The sensor network 280 may include independent devices with onboard processing that communicate with the processing circuitry 210 of the control circuitry 110 via a single data bus, or via individual communication ports. However, in some cases, one or more of the devices of the sensor network 280 may rely on the processing power of the processing circuitry 210 of the control circuitry 110 for the performance of their respective functions. As such, in some cases, one or more of the sensors of the sensor network 280 (or portions thereof) may be embodied as portions of the object detection module 240, the speech recognition module 250, the classification module 260, and/or the mapping module 270, and any or all of such sensors may employ the camera 135.

In an example embodiment, the three-dimensional sensor device 100 is provided with an IR emitter 120. The IR emitter 120 projects specked dots of IR light into a field of view by projecting an IR light source through a diffractive element diffuser located within the three-dimensional sensor device 100. Accordingly, objects in the field of view will exhibit a unique IR dot pattern based on their distances from the three-dimensional sensor device 100.

In an example embodiment, the three-dimensional sensor device 100 is provided with a color sensor 130. The color sensor 130 may be configured to capture visible light images of objects within a field of view. As such, the color sensor 130 may be an RGB camera. The color sensor 130 may interact with the classification module 260 by capturing images of objects to be compared with known images of objects stored in the image library.

In an example embodiment, the three-dimensional sensor device 100 is provided with a camera 135 in addition to any other sensors the three-dimensional sensor device 100 may carry. The camera 135, and perhaps also other sensor equipment, may be configured to gather image data and other information during operation of the three-dimensional sensor device 100. The image data may be of known objects (e.g., clocks, chairs, tables and/or the like) to update an image library. Alternatively or in addition, the image data may be of new objects encountered by the three-dimensional sensor device 100 to be compared with the images of known objects (e.g., clocks, chairs, tables and/or the like) stored in the image library.

In an example embodiment, the three-dimensional sensor device 100 is provided with an IR depth sensor 140. The IR depth sensor 140 may be calibrated based on an expected normal pattern of IR dots. Based on that calibration, the IR depth sensor 140 may measure the displacement of the dots in the presence of an object and then can calculate the distance of objects in the image. For objects near the three-dimensional sensor device 100, the pattern is spread out, for objects further from the three-dimensional sensor device 100, the dots are dense. The IR depth sensor 140 works by utilizing the IR emitter 120 and a monochrome CMOS camera to see the room in 3D regardless of the lighting conditions.

The IR depth sensor 140 may interact with the object detection module 140 and the processing circuitry 210 to detect the distance between the three-dimensional sensor device 100 and an object. Specifically, the object detection module 140 and/or the processing circuitry 210 may utilize open source programming (e.g., OpenCV from Intel) to detect the distance between the three-dimensional sensor device 100 and an object. The open source programming may include a library that has more than 2500 optimized algorithms, which includes a comprehensive set of both classic and state-of-the-art computer vision and machine learning algorithms. These algorithms can be used to detect and recognize faces, classify human actions in videos, track camera movements, track moving objects, extract 3D models of objects, produce 3D point clouds from stereo cameras, stick images together to produce a high resolution image of an entire scene, remove red eyes from images taken using flash and/or the like.

In this open source library, there are two main methods for real time object detection, SURF and HAAR. SURF is a rotationally-invariant interest point detector and descriptor. This descriptor was made to outperform previous detector as it relies on integral images for images resizing and transformations. In order to detect eyes, SURF has a specific method consisting of four main steps. First, it finds the interest points in the image. Next, it determines the orientation of these points relative to the trained′ classifier. After that, SURF creates a suitably oriented square region, which is divided up into 64 sub squares. Finally, it uses these squares to create descriptors that can be used to detect objects in an image.

HAAR classifiers are significantly simpler in the ways they detect objects. First a classifier is trained with a few thousand-sample views of a particular object (positive images contain the object, and negative images do not). This classifier can then be applied to a region of interest. It will output a “1” if the region is likely to show an object, or a “0” otherwise. To search for an object in the whole image, one can move the search window across the image and check every location using the classifier.

Creating a HAAR Classifier can be a tedious task and documentation on creating such classifiers is available in the OpenCV documentation available online (http://docs.opencv.org/doc/userguide/ugtraincascade.html) and multiple classifiers have been created by individuals in the public domain largely for detecting eyes, limbs or faces. Typically, several thousand positive and negative images are needed to create a robust classifier.

Processing is an open source platform which can be used to link together other open source devices and is an open source programming language and integrated development environment (IDE) built with the purpose of teaching the fundamentals of computer programming in a visual context. One of the stated aims of Processing is to act as a tool to get non-programmers started with programming, through the instant gratification of visual feedback. The language builds on the Java language, but uses a simplified syntax and graphics-programming model. (“Processing.org”). Such an open source platform was used to program and couple the object detection based on OpenCV with Object location based on the IR sensor from the Kinect (which contains the IR sensors and a camera by Microsoft for Xbox) in the present invention. Once coupled the device was able to identify an object and then guide the individual to its location.

In an example embodiment, the three-dimensional sensor device 100 is provided with a leveling sensor 150. The leveling sensor 150 may include at least one of a gyroscope and/or a servomechanism. Use of gyroscopes and servomechanisms make it possible to insure that the three-dimensional sensor device 100 is level at all times. Additionally, the use of gyroscopes and/or servomechanisms may permit the three-dimensional sensor device 100 to detect objects at multiple levels.

In an example embodiment, the three-dimensional sensor device 100 is provided with a voice sensor 160. In order to recognize the voice of the user and relay commands back to the three-dimensional sensor device 100, the voice sensor 160 may include a device (e.g., EasyVR) and/or an open source platform (e.g., Voce). The device may be a multi-purpose speech recognition device designed to easily add versatile, robust, and cost effective multi-language speech recognition capabilities to almost any other device. The open source platform may be an open source speech synthesis and recognition library that is a cross-platform accessible from Java and C++. Furthermore, a program (e.g., TTS) may be used to give vocal responses to the operator. Specific commands (e.g., “find object”, “stop detection”) may be used as trigger words for the voice sensor 160.

In an example embodiment, the processing circuitry 210 integrates all data from the sensor network 280 and modules. The processing circuitry 210 may utilize an open source platform (e.g., Processing) which can be used to link together all of the other open source devices in the three-dimensional sensor device 100. The open source platform may include an open source programming language and integrated development environment (IDE). The language builds on the Java language but uses a simplified syntax and graphics-programming model. The open source platform may be used to program and couple the object detection module 240 and IR depth sensor 140. Once coupled the three-dimensional sensor device 100 may be able to identify an object and then guide an operator to its location.

In an example embodiment, the object detection module 240 may be configured to employ sensors of the sensor network 280, the camera 135, and/or other information to detect objects. Object detection may occur relative to static objects that may be fixed/permanent and non-moving, but also not fixed or permanent objects. Such objects may be known (if they have been encountered before at the same position) or unknown (if the present interaction is the first interaction with the object or a first interaction with an object at the corresponding location). Object detection may also occur relative to dynamic objects that may be moving. In some cases, the dynamic objects may also be either known or unknown.

In an example embodiment, the three-dimensional sensor device 100 may be configured to facilitate object recognition and distance detection. In some cases, the three-dimensional sensor device 100 may be configured to detect the location of an object at a later time to see if the object has moved if it is not a known fixed object. The object can therefore be learned to be a fixed object, or the object may have moved and the three-dimensional sensor device 100 can then conduct its distance detecting operations where the object is currently located. In any case, the object detection module 240 may employ sensors of the sensor network 280 to ensure that the three-dimensional sensor device 100 can identify an object and/or detect the distance between the object and the three-dimensional sensor device 100.

In an example embodiment, the speech recognition module 250 may be configured to detect and respond to operator speech patterns. Specifically, the speech recognition module 250 may be configured to detect operator speech patterns, understand operator instructions to locate an object, detect the object, audibly notify the operator of the position of an object, and/or the like. Thus, the speech recognition module 250 may include components that enable the three-dimensional sensor device 100 to understand and follow operator instructions.

In an example embodiment, the classification module 260 may be configured to classify objects encountered by the three-dimensional sensor device 100. Classifications of known and unknown objects may be accomplished using the classification module 260 based on machine learning relative to known images. For example, the classification module 260 or processing circuitry 210 may store images of previously encountered objects or other objects that are to be learned as known objects (e.g., clocks, chairs, tables and/or the like). When an object is encountered during operation of the three-dimensional sensor device 100, if the camera 135 is able to obtain a new image of the object, the new image can be compared to the stored images to see if a match can be located. If a match is located, the new image may be classified as a known object. In some cases, a label indicating the identity of the object may be added to the image library in association with any object that is known.

In an example embodiment, the mapping module 270 may be configured to generate an auditory map of the current positions of objects in an area in which the three-dimensional sensor device 100 operates. Additionally, the mapping module 270 may be configured to facilitate operation of the three-dimensional sensor device 100 relative to an existing (or previously generated) auditory map of the area.

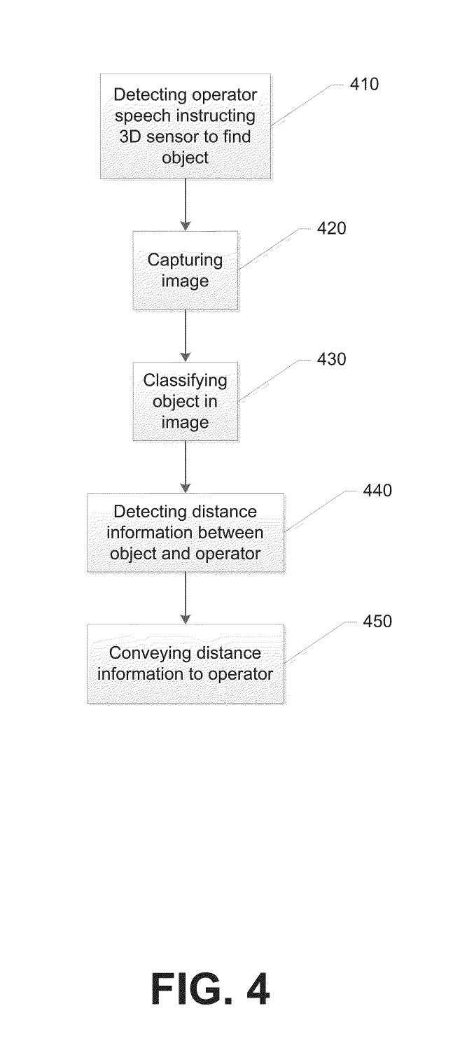

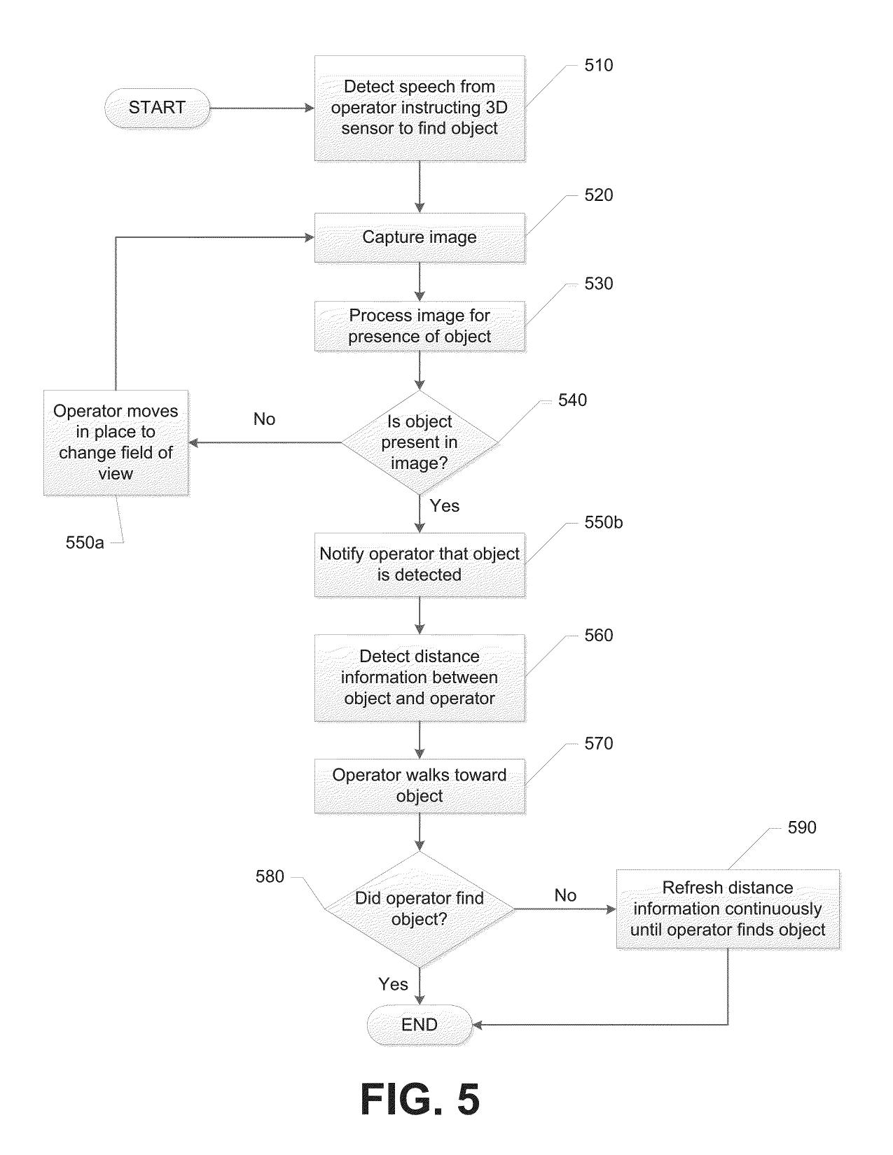

Embodiments of the present invention may therefore be practiced using an apparatus such as the one depicted in FIGS. 1-3. However, it should also be appreciated that some embodiments may be practiced in connection with a computer program product for performing embodiments or aspects of the present invention. As such, for example, each block or step of the flowcharts of FIGS. 4-5, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., memory 215) and executed by processing circuitry (e.g., processor 220).

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s) or step(s). These computer program instructions may also be stored in a computer-readable medium comprising memory that may direct a computer or other programmable apparatus to function in a particular manner, such that the instructions stored in the computer-readable memory produce an article of manufacture including instructions to implement the function specified in the flowchart block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s) or step(s). In this regard, a method according to example embodiments of the invention may include any or all of the operations shown in FIGS. 4-5. Moreover, other methods derived from the descriptions provided herein may also be performed responsive to execution of steps associated with such methods by a computer programmed to be transformed into a machine specifically configured to perform such methods.

In an example embodiment, a method of object recognition according to FIG. 4 may include detecting speech instructing a three-dimensional sensor device 100 to find an object at operation 410, capturing an image at operation 420, classifying the object in the image at operation 430, detecting location information of the object relative to the operator at operation 440 (which may be in the form of distance information between the object and the operator), and conveying the information to the operator at operation 450.

FIG. 5 illustrates a control flow diagram of one example of how the three-dimensional sensor device 100 can be operated to locate objects according to certain embodiments of the present invention. As shown in FIG. 5, operation may begin with detecting speech instructing a three-dimensional sensor device 100 to find an object at operation 510. Operation may continue with capturing an image at operation 520. Operation may continue with processing the image for presence of an object at operation 530. The operation may continue at operation 540 by making a decision as to whether the object is present in the image. In this regard, if the decision is made that the object is not present in the image, then the operator will move in place to change the field of view at operation 550a, and the three-dimensional sensor device 100 will return to operation 520 and proceed through operations 530 and 540 until the object is present in the image. However, if the decision is made that the object is present in the image, then the three-dimensional sensor device 100 will notify the operator that the object has been detected at operation 550b. Operation may continue by detecting location information of the object relative to the operator at operation 560 (which may be in the form of distance information between the object and the operator). Operation may continue with the operator walking toward the object at operation 570. The operation may continue at operation 580 by making a decision as to whether the operator found the object. In this regard, if the decision is made that the operator did find the object, then operation will conclude. However, if the decision is made that the operator did not find the object, then the three-dimensional sensor device 100 will refresh distance information continuously until the operator finds the object at operation 590, at which point operation will conclude.

As such, in some cases, the three-dimensional sensor device 100 may generally operate in accordance with a control method that combines the modules described above to provide a functionally robust three-dimensional sensor device 100. In this regard, a method according to example embodiments of the invention may include any or all of the operations shown in FIG. 5. Moreover, other methods derived from the descriptions provided herein may also be performed responsive to execution of steps associated with such methods by a computer programmed to be transformed into a machine specifically configured to perform such methods.

In an example embodiment, an apparatus for performing the methods of FIGS. 4-5 above may comprise processing circuitry (e.g., processing circuitry 210) that may include a processor (e.g., the processor 220) configured to perform some or each of the operations (410-450, 510-590) described above. The processing circuitry 210 may, for example, be configured to perform the operations (410-450, 510-590) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (410-450, 510-590) may comprise, for example, the processing circuitry 210.

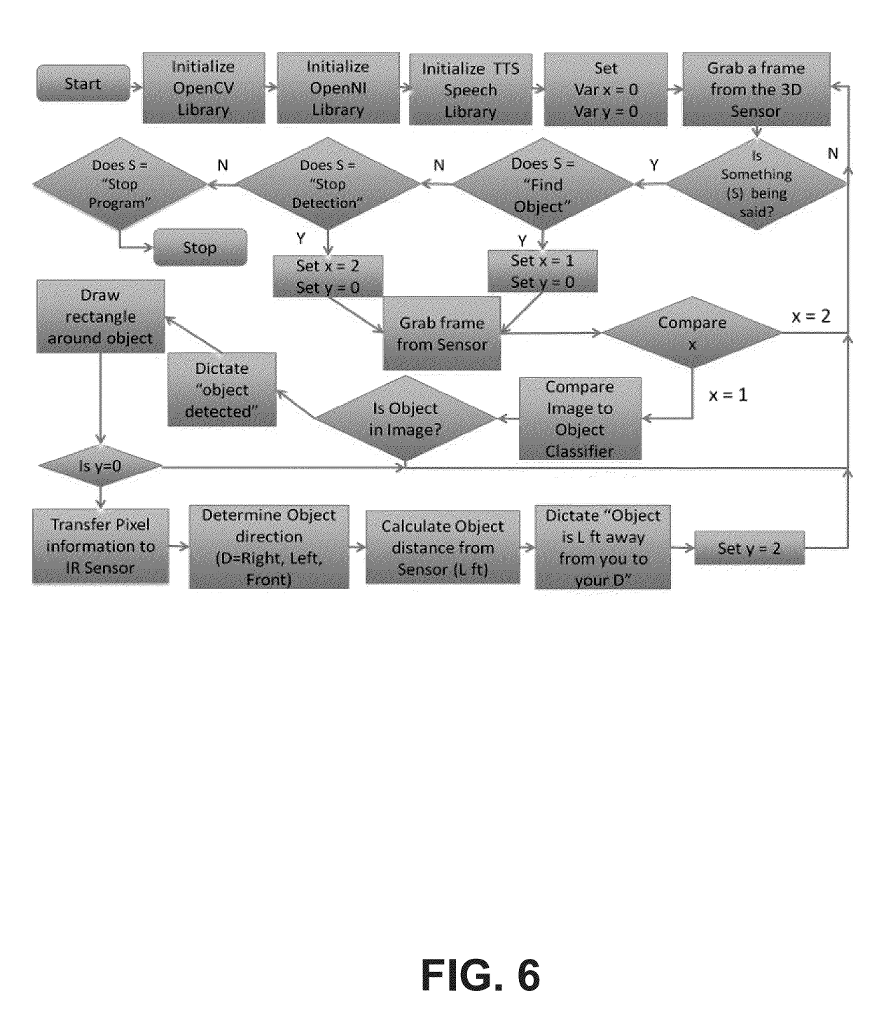

FIG. 6 illustrates a control flow diagram of the operation of the basic algorithm according to certain embodiments of the present invention. Specifically, FIG. 6 illustrates the basic functionality of the program in order to provide a command to the three-dimensional sensor device 100, have it identify the object in the frame of interest, and then guide the individual to this object. In order to avoid false positives, a smoothing functionality can be incorporated into the program. By using image averaging, false positives can be eliminated.

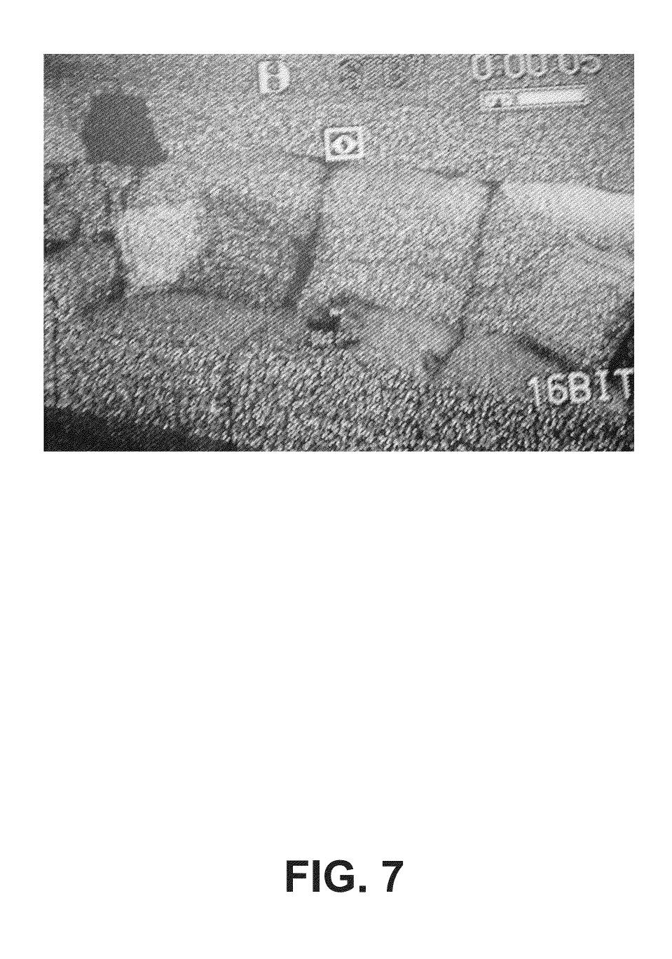

FIG. 7 illustrates specked dots of IR light projected onto an object with the three-dimensional sensor device 100 according to certain embodiments of the present invention. As shown in FIG. 7, the three-dimensional sensor device 100 uses an IR emitter 120 and a monochrome CMOS camera to see the room in 3D regardless of the lighting conditions. For objects near the three-dimensional sensor device 100, the pattern is spread out, for objects further from the three-dimensional sensor device 100, the dots are dense.

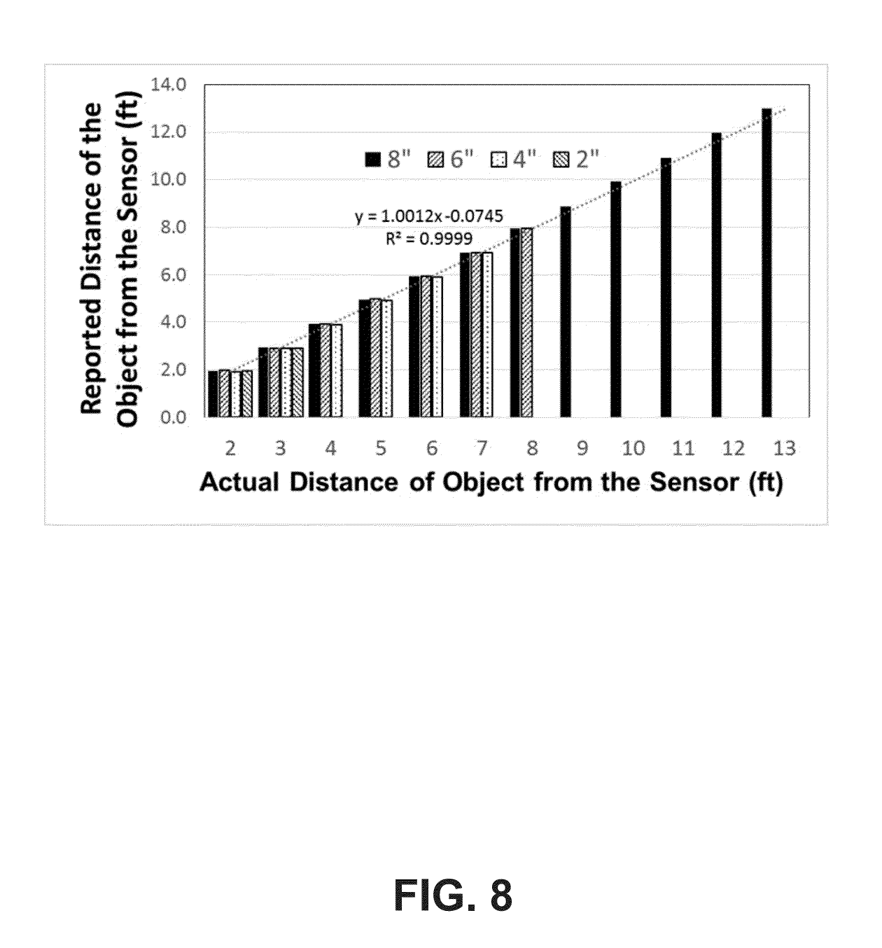

FIG. 8 illustrates the effects of object size and distance of object from the three-dimensional sensor device 100 on accuracy of sensor-reported distance of object from the three-dimensional sensor device 100. As shown in FIG. 8, the three-dimensional sensor device 100 detects objects with excellent accuracy.

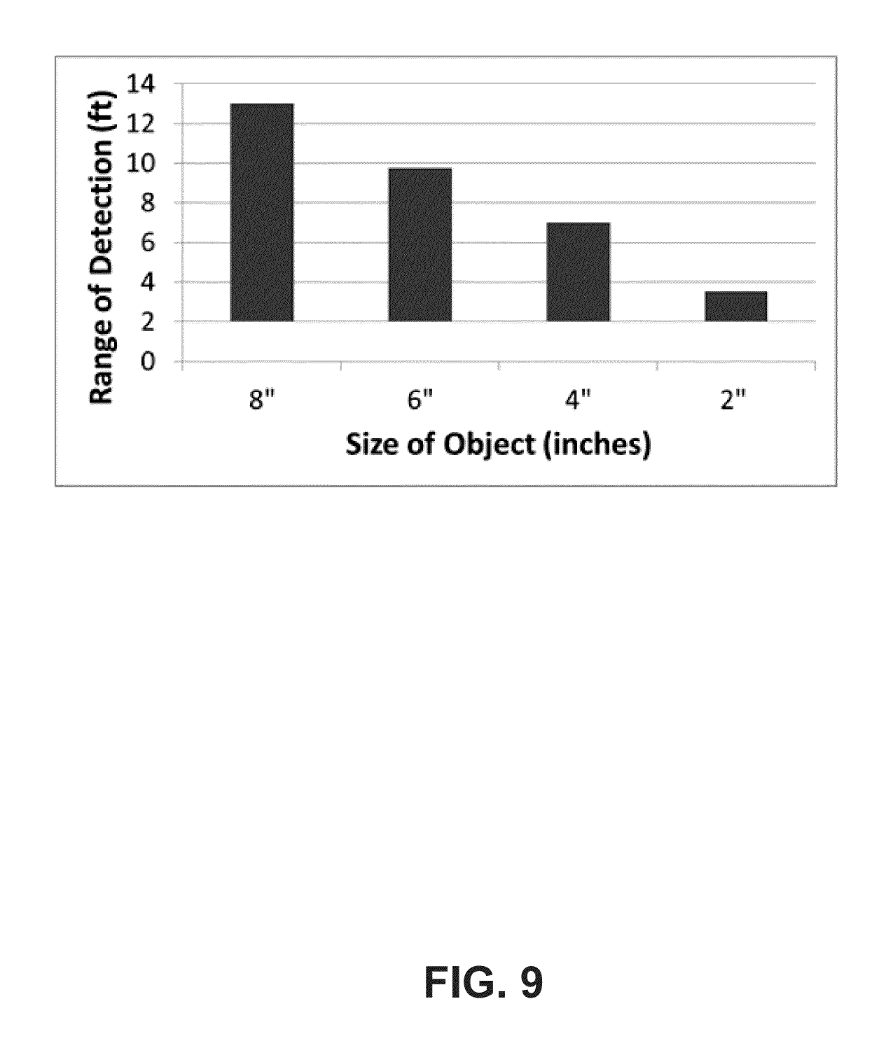

FIG. 9 illustrates the effects of object size on detection range of the three-dimensional sensor device 100. As shown in FIG. 9, the three-dimensional sensor device 100 demonstrates a larger range of detection for larger objects. Specifically, FIG. 9 illustrates that an object of 8 inches may be detected within a range of 13 feet. As such, the device may be practical to use in mid-size rooms.

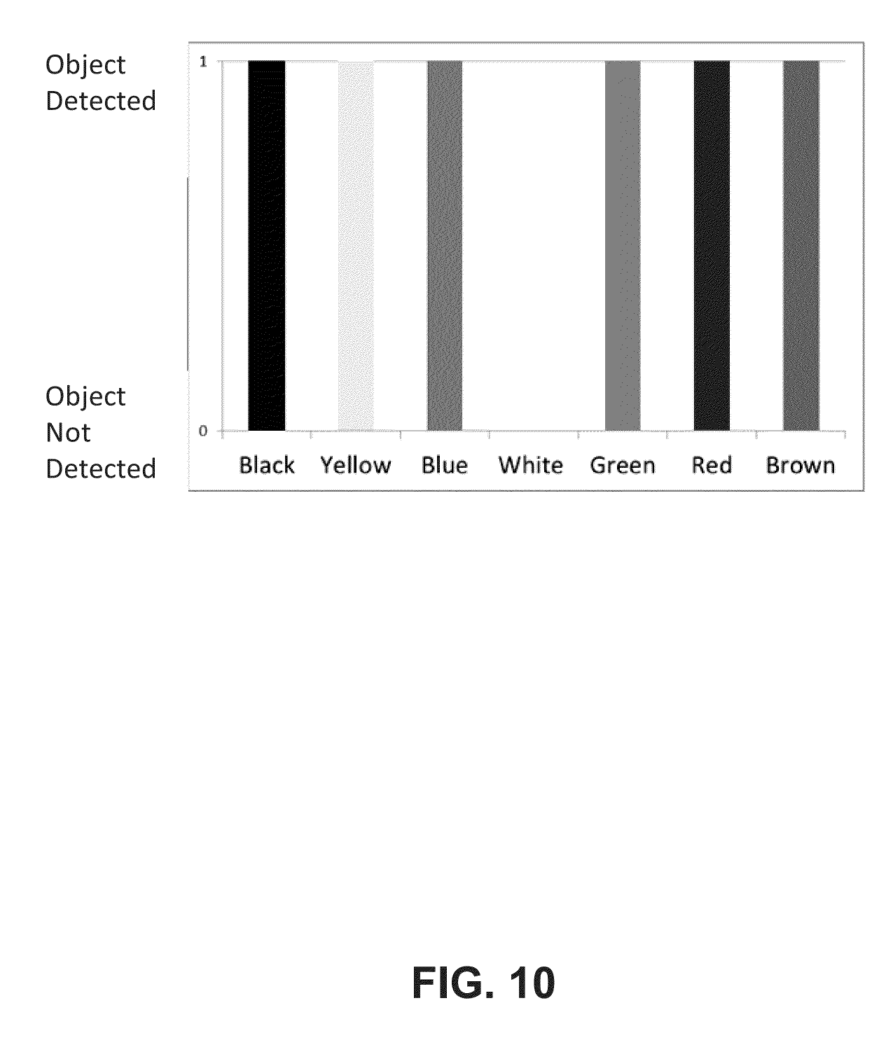

FIG. 10 illustrates the effects of background color on detection of the object by a three-dimensional sensor device 100. As shown in FIG. 10, when a white object is placed in front of different colored backgrounds, the three-dimensional sensor device 100 may be capable of detecting the objects with every colored background except for a white background when using a HAAR classifier algorithm for object detection. This is a function of the algorithm used for object detection, which in an exemplary embodiment such as described herein is a HAAR classifier. Variable methodologies might employ other devices.

Having described various aspects and embodiments of the invention herein, further specific embodiments of the invention include those set forth in the following paragraphs.

Certain embodiments according to the present invention provide a method of object recognition. In general, the method includes detecting operator speech instructing a three-dimensional sensor device to find an object; capturing an image; classifying the object in the image; detecting location information of the object relative to the operator (which may be in the form of distance information between the object and the operator); and conveying the information to the operator.

In accordance with certain embodiments of the present invention, the three-dimensional sensor device comprises processing circuitry configured for detecting operator speech instructing a three-dimensional sensor device to find an object; capturing an image; classifying the object in the image; detecting location information of the object relative to the operator (which may be in the form of distance information between the object and the operator); and conveying the information to the operator. In certain embodiments, the three-dimensional sensor device comprises a sensor network comprising one or more sensors configured to detect conditions proximate to the three-dimensional sensor device; a speech recognition module configured to detect and respond to operator speech patterns; an object detection module configured to detect objects proximate to the three-dimensional sensor device using contact-less detection; and a classification module configured to compare images received from the sensor network with known images stored in the image library or features of images that the sensor device has been trained to recognize. In such embodiments, the sensor network comprises at least one of a camera, an infrared (IR) depth sensor, an IR emitter, a leveling sensor, a voice sensor, or any combination thereof.

In accordance with certain embodiments of the present invention, the speech recognition module is configured to receive speech information from at least one of the voice sensor or the camera. In some embodiments, the classification module is configured to receive object detection information from at least one of the camera or the IR depth sensor. In certain embodiments, the camera provides images of objects to the classification module to compare the images with images of known objects from the image library. In other embodiments, the camera provides images of objects to the classification module to compare the images with features of images that the sensor has been trained to recognize, regardless of whether the images are stored in a library. According to some embodiments, the object detection module is configured to receive location information or distance information from IR dot patterns from at least one of the camera, the IR emitter, the IR depth sensor, or any combination thereof.

In accordance with certain embodiments of the present invention, the method further comprises generating an auditory map of an area in which the three-dimensional sensor operates. In such embodiments, generating the auditory map of the area comprises incorporating input from multiple sensors of the sensor network into a mapping module to determine current position of objects in the area.

In another aspect, the present invention provides a three-dimensional sensor device. In general, the three-dimensional sensor device includes a sensor network comprising one or more sensors configured to detect conditions proximate to the three-dimensional sensor device; a speech recognition module configured to detect and respond to operator speech patterns; an object detection module configured to detect objects proximate to the three-dimensional sensor device using contact-less detection; and a classification module configured to compare images received from the sensor network with known images stored in the image library or features of images that the sensor device has been trained to recognize.

In accordance with certain embodiments of the present invention, the three-dimensional sensor device further comprises processing circuitry configured for detecting operator speech instructing a three-dimensional sensor device to find an object; capturing an image; classifying the object in the image; detecting location information of the object relative to the operator (which may be in the form of distance information between the object and the operator); and conveying the information to the operator.

In accordance with certain embodiments of the present invention, the sensor network comprises at least one of a camera, an infrared (IR) depth sensor, an IR emitter, a leveling sensor, a voice sensor, or any combination thereof. In such embodiments, the speech recognition module is configured to receive speech information from at least one of the voice sensor or the camera. In certain embodiments, the object detection module is configured to receive location information or distance information from IR dot patterns from at least one of the camera, the IR emitter, the IR depth sensor, or any combination thereof. In some embodiments, the classification module is configured to receive object detection information from at least one of the camera or the IR depth sensor. In certain embodiments, the camera provides images of objects to the classification module to compare the images with images of known objects from the image library.

In accordance with certain embodiments of the present invention, the three-dimensional sensor device further comprises a mapping module configured to generate an auditory map of an area in which the three-dimensional sensor device operates. In such embodiments, the mapping module is configured to incorporate input from multiple sensors of the sensor network to determine current positions of multiple objects in the area.

In accordance with certain embodiments of the present invention, the three-dimensional sensor device is positioned in a wearable item. In such embodiments, the wearable item includes at least one of a harness, apparel, or glasses.

These and other modifications and variations to the present invention may be practiced by those of ordinary skill in the art without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

What is claimed is:

1. A method of object recognition, comprising:
(a) detecting operator speech instructing a three-dimensional sensor device to find an object;
(b) capturing an image;
(c) classifying the object in the image;
(d) detecting location information of the object relative to the operator; and
(e) conveying the location information to the operator until the object is found.

2. The method according to claim 1, wherein the three-dimensional sensor device comprises processing circuitry configured for:
(a) detecting operator speech instructing a three-dimensional sensor device to find an object;
(b) capturing an image;
(c) classifying the object in the image;
(d) detecting location information of the object relative to the operator; and
(e) conveying the location information to the operator until the object is found.

3. The method according to claim 1, wherein the three-dimensional sensor device comprises:
(a) a sensor network comprising one or more sensors configured to detect conditions proximate to the three-dimensional sensor device;
(b) a speech recognition module configured to detect and respond to operator speech patterns;
(c) an object detection module configured to detect objects proximate to the three-dimensional sensor device using contact-less detection; and
(d) a classification module configured to compare images received from the sensor network with known images stored in the image library or features of images that the sensor device has been trained to recognize.

4. The method according to claim 3, wherein the sensor network comprises at least one of a camera, an infrared (IR) depth sensor, an IR emitter, a leveling sensor, a voice sensor, or any combination thereof.

5. The method according to claim 4, wherein the speech recognition module is configured to receive speech information from at least one of the voice sensor or the camera.

6. The method according to claim 4, wherein the classification module is configured to receive object detection information from at least one of the camera or the IR depth sensor.

7. The method according to claim 6, wherein the camera provides images of objects to the classification module to compare the images with images of known objects from the image library or features of images that the sensor device has been trained to recognize

8. The method according to claim 4, wherein the object detection module is configured to receive distance information from IR dot patterns from at least one of the camera, the IR emitter, the IR depth sensor, or any combination thereof.

9. The method according to claim 1, further comprising generating an auditory map of an area in which the three-dimensional sensor operates.

10. The method according to claim 9, wherein generating the auditory map of the area comprises incorporating input from multiple sensors of the sensor network into a mapping module to determine current position of objects in the area.

11. A three-dimensional sensor device, comprising:
(a) a sensor network comprising one or more sensors configured to detect conditions proximate to the three-dimensional sensor device;
(b) a speech recognition module configured to detect and respond to operator speech patterns;
(c) an object detection module configured to detect objects proximate to the three-dimensional sensor device using contact-less detection; and
(d) a classification module configured to compare images received from the sensor network with known images stored in the image library or features of images that the sensor device has been trained to recognize.

12. The three-dimensional sensor device according to claim 11, further comprising processing circuitry configured for:
(a) detecting speech from an operator instructing a three-dimensional sensor device to find an object;
(b) capturing an image;
(c) classifying the object in the image;
(d) detecting location information of the object relative to the operator; and
(e) conveying the location information to the operator.

13. The three-dimensional sensor device according to claim 11, wherein the sensor network comprises at least one of a color sensor, an infrared (IR) depth sensor, an IR emitter, a leveling sensor, a voice sensor, or any combination thereof.

14. The three-dimensional sensor device according to claim 13, wherein the speech recognition module is configured to receive speech information from at least one of the voice sensor or the camera.

15. The three-dimensional sensor device according to claim 13, wherein the object detection module is configured to receive distance information from IR dot patterns from at least one of the camera, the IR emitter, the IR depth sensor, or any combination thereof.

16. The three-dimensional sensor device according to claim 13, wherein the classification module is configured to receive object detection information from at least one of the camera or the IR depth sensor.

17. The three-dimensional sensor device according to claim 16, wherein the camera provides images of objects to the classification module to compare the images with images of known objects from the image library or features of images that the sensor device has been trained to recognize.

18. The three-dimensional sensor device according to claim 11, further comprising a mapping module configured to generate an auditory map of an area in which the three-dimensional sensor device operates.

19. The three-dimensional sensor device according to claim 18, wherein the mapping module is configured to incorporate input from multiple sensors of the sensor network to determine current positions of multiple objects in the area.

20. The three-dimensional sensor device according to claim 11, wherein the three-dimensional sensor device is positioned in a wearable item.

21. The method according to claim 1, wherein the operator is visually impaired.

22. The method according to claim 1, wherein the location information is distance information between the object and the operator.

23. The method according to claim 2, wherein the operator is visually impaired.

24. The method according to claim 2, wherein the location information is distance information between the object and the operator.

25. The method according to claim 12, wherein the operator is visually impaired.

26. The method according to claim 12, wherein the location information is distance information between the object and the operator.
